(19) United States
(12) Patent Application Publication
(10) Pub. No.: US 2015/0227853 A1
(43) Pub. Date: Aug. 13, 2015

(54) METHOD AND APPARATUS FOR TEMPORARILY ASSIGNING ACCESS TO ASSETS IN RESPONSE TO RESERVATION REQUESTS

(71) Applicants: PIERRE BOETTNER, SANTA CRUS, CA (US); DENIS BAJET, SUNNYVALE, CA (US)

(72) Inventors: PIERRE BOETTNER, SANTA CRUS, CA (US); DENIS BAJET, SUNNYVALE, CA (US)

(21) Appl. No.: 14/175,938

(22) Filed: Feb. 7, 2014

(51) Int. Cl. G06Q 10/02; G06Q 30/06

(52) U.S. Cl. CPC G06Q 10/02; G06Q 30/0645

(57) ABSTRACT

A method and system for allocating temporary assignments of access to nonhomogeneous assets to a plurality of parties is provided. The assets are each designated as being of a certain type of at least two value types. Assets and asset access requests (“request”) are further designated as having one or more particular distinguishing features. The requests are generally ordered according to a value ranking The assets are then assigned by first assigning lower typed assets to the lower ranked requests. When all assets of a lower type are assigned, the remaining unassigned requests are assigned to unassigned assets of the next higher type. When all assets of the highest type are assigned, selected assets may be then reassigned to insure that higher valued requests are assigned to assets and permitting lower valued requests to (a.) be assigned to lower valued assets; or (b.) be unassigned and thereby denied.

### FIELD OF THE INVENTION

The present invention relates to methods and systems for assigning time-limited access to a plurality of assets among pluralities of parties. More particularly, the method of the present invention addresses the desire to more effectively assign and deny access to assets on the basis of pluralities of requests of distinguishable qualities.

### BACKGROUND OF THE INVENTION

Many well established business models are fundamentally organized around enabling access to, or usage or rental of, facilities and equipment on a time limited basis and/or an actual usage basis, such as the car rental sector and hotel and hospitality industries. In addition, many more industry and civic sectors are newly and increasingly influenced by the values of the sharing economy, wherein equipment, facilities, venues and services are preferably allocated on a time sliced basis whereby the need for purchase of duplicative equipment and materials is avoided. The prior art provides information technology systems that assist users in scheduling time-limited access to proprietary equipment and facilities, and commits the provision of attendant consumables in conjunction with agreements that specify reserving, renting, leasing, loaning, staging and positioning of specified venues, locales, objects, systems and machinery. Yet the prior art fails to enable a human system administrator to optimally review, adjust, finalize and approve commitments and possible denials of access to assets suggested by an information technology system which would have calculated and suggested one or more patterns of use and assignment of existing assets in order to optimize the fulfillment of existing reservation requests.

In one aspect of the prior art, assets are often broadly categorized into types wherein certain features of the specific assets are neither recorded nor applied within an automated asset access assignment method. In another aspect of the prior art, preferences of aspects of assets that are especially desirable to individual requestors are neither accepted nor considered within an automated asset access assignment method.

There is therefore a long felt and increasing need to provide improved systems and method that enable a sys admin to partially automate and personally intervene and modify assignments of asset access in view of a plurality of asset access reservation requests.

### SUMMARY AND OBJECTS OF THE INVENTION

Toward these objects and other objects that are made obvious to one of ordinary skill in the art in light of the present disclosure, a method, system and device are provided that accept and analyze asset access requests and enable a human system administrator or other human operator of an information technology system (hereinafter, a “sys admin”) to thereafter modify, reject, accept and implement asset access reservations. The access may be or comprise permission or license to use, access or rent an equipment, service, facility or venue.

This Summary is provided to introduce a selection of concepts in a simplified form that are further described below in the Detailed Description. Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

In a first aspect of the method of the present invention, a reservation system is established that records a plurality of assets of distinguishable and optionally with differing features, such as, and not limited to, printing press machinery, hotel rooms and automobiles. The reservation system preferably individually designates some or all of the assets as being of a particular type, class or level, wherein these distinctions by quality or genus are preferably hierarchically ordered. The reservation system may additionally and optionally maintain user records that associate individually identifiable persons, organizations or entities as (a.) having one a membership program status, (b.) being of a relative or absolute value or desirability level of customer retention, and/or (c.) having one or more particular asset feature preferences.

The method of the present invention (hereinafter, “the invented method”) includes the aspects of associating an asset type to each reservation request, optionally including a null or default type, and the attempt to assign each reservation request to a plurality of assets in view of (a.) a requested time of access, use and/or rental, (b.) optionally a provided arbitrary or calculated value of the reservation request of interest; and (c.) availability of the assets in relation to requested times and/or time periods of requested access. The invented method further optionally include, after a completion of a process of assignments of assets in order from lowest type assets to higher or highest type assets to a plurality of reservation requests, an automated reassignment of assets to reservation requests in view of relative values of each of the plurality of reservation requests, wherein the reassignment process is made in order from higher or highest type of asset type to lower, lowest or default asset type. It is understood that the automated aspects of the invented method generate suggestions intended for review and modification by a sys admin and are generally adjustable by the sys admin.

Assets that may be assigned within the objects of the method of the present invention include, but are not limited to, time constrained assets, time delineated services, hotel rooms, rental vehicles, venue seats, rights of event attendance, software licenses, access licenses, airplanes, airplane seats during a flight, event spaces, transportation capacity units, a service provider's time, and equipment of which access to or usage of is time constrained. It is understood that the scope of the meaning of the term “asset” as applied and defined in the present disclosure includes services, equipment, objects, venues, facilities, digitally stored data, documents, and time lengths of availability, access, usage, service and/or presence.

According to yet another optional aspect of the invented method, a reservation request may include an indication of a desired feature of an asset, and an asset indicated as including the desired feature may be selectively assigned to the reservation request in recognition of the association of the desired asset feature with the relevant reservation request. A feature match is found to exist in the invented process when an asset is indicated to have or be associated with a quality, aspect or element that a matching reservation request indicates as being desirable to a requestor associated with the potentially matching reservation request. It is understood that a feature may be a negative state or quality, such as seeking an automobile with less than four doors or seeking a room not located within one hundred meters of a music venue.

In one optional aspect of the invented method, assignments of assets are made in order from a lower or lowest rated asset quality level to a higher or highest rated asset quality level, wherein (a.) reservation requests are each associated with a predesignated quality level; (b.) assignments of reservation requests are made in an order of preference from the lowest valued reservation requests to the highest valued reservation requests with a plurality of assets of a same quality level in a one-to-one correspondence; (c.) when assets of a same quality level are associated with differing asset values, assets are assigned to reservation requests in order within the same quality level from the asset with the lowest associated asset value to the asset with the highest associated asset value; and (d.) when each asset of a same quality level is assigned to a reservation requests, some or all remaining unassigned reservation requests of that instant quality level or lower quality level are considered for assignment to a next higher quality level of assets. Optionally, feature fitting may be performed in accordance with the invented method, wherein a reservation request that specifies a preference for a particular asset feature directs the invented method to seek an asset that is designated as providing the requested feature for assignment to the instant reservation request.

In accordance with yet another optional aspect of the invented method, assignments of assets to reservation requests are first made in order from lowest to highest quality level and then evaluated for reassignment in an order extending from highest quality level to lowest quality level. In a descending quality level process, assignments of assets are made in order of from a highest or higher asset quality level to a lower or lowest asset quality level, wherein (a.) assignments of reservation requests are made in an order of preference from the highest valued reservation requests to the lowest valued reservation requests within a plurality of assets of a same quality level in a one-to-one correspondence; (b.) when assets of a same quality level have differing asset values, assets are assigned to reservation requests in order within the same quality level from the asset with the lowest associated asset value to the asset with the highest associated asset value; and (c.) when each asset of a same quality level is assigned to a reservation requests, some or all remaining unassigned reservation requests of that instant quality level or lower quality level are considered for assignment to a next lower quality level of assets.

In a still additional optional aspect of the invented method, the process of assigning and reassigning assets to reservation requests may be iteratively performed under different limitations and constraints. In addition, one or more reservation requests may be designated for denial of assignment to an asset. Denials of reservations are preferably determined after the denied reservation request has been considered for assignment to an asset in a process that included at least one ascent and subsequent descent through the asset quality levels.

### BRIEF DESCRIPTION OF THE DRAWINGS

These and other features, aspects, and advantages of the present disclosure will become better understood when the following detailed description of certain exemplary embodiments is read with reference to the accompanying drawings in which like characters represent like parts throughout the drawings, wherein:

FIG. 1 is a representation of a software record that includes a listing of hotel rooms of a same hotel and associated counts of rooms by an assigned quality level of each room;

FIG. 2 is a representation of a first asset record related to a first hotel room;

FIG. 3 is a representation of a first reservation request related to a first hotel room reservation request message;

FIG. 4 is a process chart of the invented method;

FIG. 5 is a representation of optional aspects of step 4.04 of FIG. 4, wherein in a method of assigning reservation requests to asset records is accomplished in an ascending order of asset quality levels;

FIG. 6 is a representation of optional aspects of step 4.04 of FIG. 4, wherein in a method of assigning and reassigning reservation requests to asset records is accomplished in a descending order of asset quality levels;

FIG. 7 is a representation of optional aspects of steps 5.04 and 5.08 of FIG. 5;

FIG. 8 is a representation of optional aspects of steps 6.06 and 6.12 of FIG. 6;

FIG. 9 is a schematic diagram of an information technology system that may be applied to effect the methods of FIG. 4 through 8 in interaction with a human operator;

FIG. 10 is an illustration of the software resident in the information technology system of FIG. 9 and that enables instantiation of the methods of FIG. 4 through 8 in interaction with a human operator;

FIG. 11 is an illustration of aspects of several asset records of FIG. 2 as stored in the data base management system of the information technology system of FIG. 9;

FIG. 12 is an illustration of aspects of several reservation request records of FIG. 3 as stored in the data base management system of the information technology system of FIG. 9;

FIG. 13 is a representation of an equipment software record that includes a listing of vehicles, such as automobiles, of a rental agency and associated counts of vehicles by an assigned quality level of each vehicle;

FIG. 14 is a representation of a first equipment asset record related to a vehicle available for rent by the rental agency of FIG. 13;

FIG. 15 is a representation of a first car rental request record related to a first car rental request message;

FIG. 16 is an illustration of aspects of several equipment records of FIG. 14 as stored in the data base management system of the information technology system of FIG. 9;

FIG. 17 is an illustration of aspects of several car rental records of FIG. 15 as stored in the data base management system of the information technology system of FIGS. 9; and

FIG. 18 is an illustration of an electronic communications network that bi-directionally communicatively couples the information technology system of FIG. 9 and FIG. 10 with reservation systems.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

While the present invention may be susceptible to various modifications and alternative forms, specific embodiments have been shown by way of example in the drawings and will be described in detail herein. However, it should be understood that the techniques set forth in the present disclosure are not intended to be limited to the particular forms disclosed. Rather, the invention is to cover all modifications, equivalents and alternatives falling within the spirit and scope of the disclosure as defined by the following appended claims.

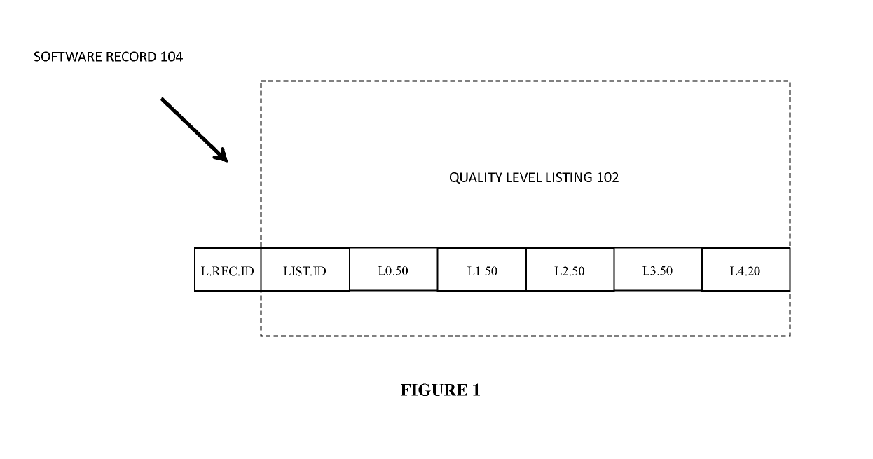

Referring now generally to the Figures and particularly to FIG. 1, the case of a hotel having a plurality of rooms of different features and quality levels is considered, wherein a hotel manager or management applies the invented method to aid in the assignment of room reservation requests REQ.01-REQ.N to available rooms, i.e. asset records A.REC.ID.01-A.REC.ID.N by means of an information technology system 100.

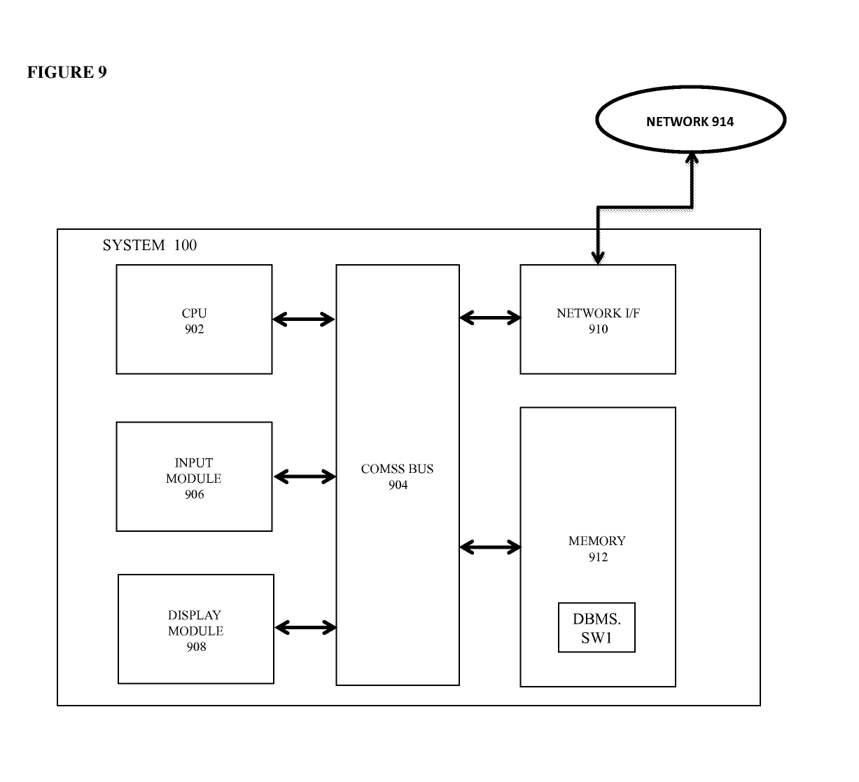

Referring now generally to the Figures and particularly to FIG. 1 and FIG. 9, FIG. 1 is a representation of a room quality level listing 102 (hereinafter “the listing” 102) stored within a software record 104 that is preferably stored in the information technology system 100 (hereinafter, “the system” 100), wherein each of five room quality levels L0-L4 has a specified numerical count of available rooms. The listing 102 further presents that the associated hotel as including 50 rooms at the first quality level L0, 50 rooms at the second quality level L1, 50 rooms at the third quality level L2, 50 rooms at the fourth quality level L3, and 20 rooms at the fifth quality level L4. These asset quality level counts, e.g., a count of 50 at the first and lowest quality level L0 and a count or 20 at the fifth and highest quality level of L4, of available rooms at each respective asset quality level L0-L4 may be used in the invented method in one or more loops of assignments of reservation requests REQ.01-REQ.N within each related quality level.

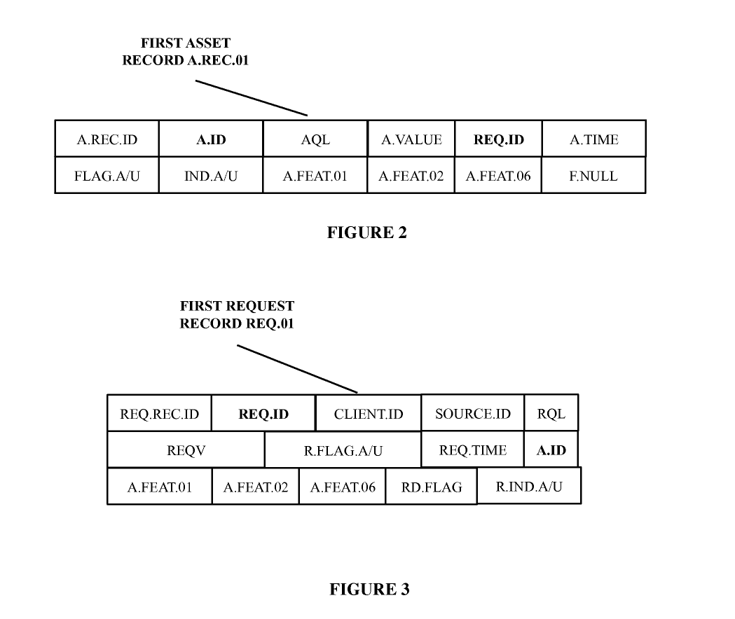

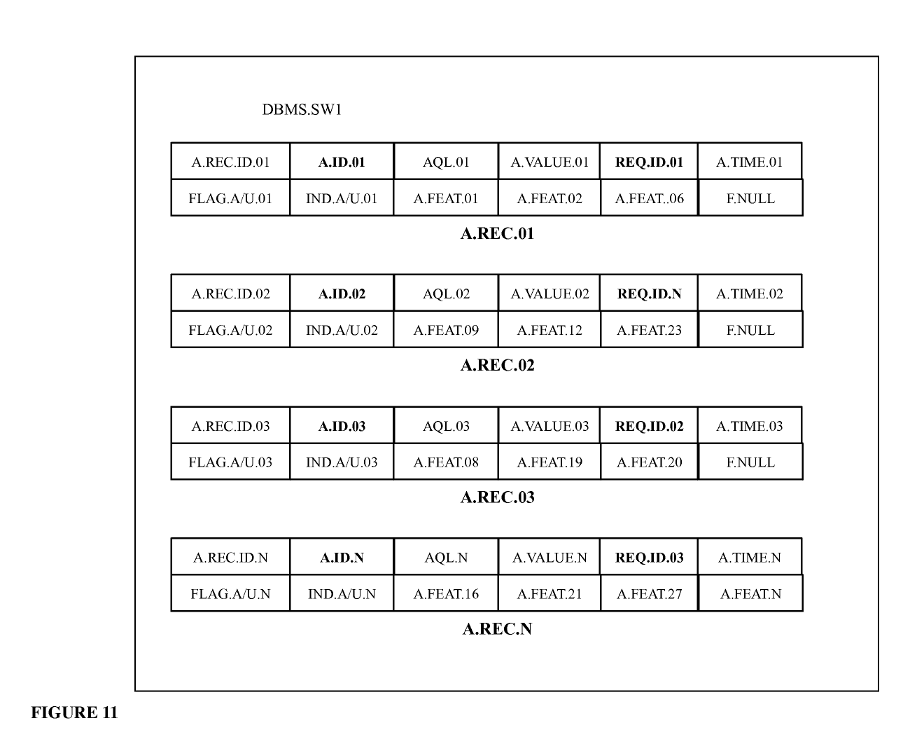

Referring now generally to the Figures and particularly to FIG. 2 and FIG. 11, FIG. 2 illustrates an exemplary first asset record A.REC.01 of a plurality of asset records A.REC.01-A.REC.N that is additionally preferably stored in the system 100. Each asset record A.REC.01-A.REC.N preferably includes a unique asset record identifier A.REC.ID, a unique asset identifier A.ID that identifies an actually existing physical asset or virtual asset, an asset quality level designator AQL of the asset identified by the asset identifier A.ID of the same asset record A.REC.01-A.REC.N, an optional asset value A.VALUE, optionally a request identifier R.ID of tentatively assigned reservation request REQ.ID.01-REQ.N, an associated time period or instance A.TIME, an assigned/unassigned flag FLAG.A/U, an asset availability indicator IND.A/U, and/or one or more optional one or more optional requested asset feature identifiers A.FEAT.01-A.FEAT.N. It is understood that one or more elements of one or more asset records A.REC.01-A.REC.N may be blank or hold null values at, or within, one or more times or time periods of application of the invented method, e.g. when no reservation request REQ.01-REQ.N is assigned to an asset record A.REC.01-A.REC.N, the unassigned asset record A.REC.01-A.REC.N may include a null or blank value in request data field reserved to store an assigned reservation request identifier REQ.ID.

Each asset assigned/unassigned flag FLAG.A/U, indicates to the system 100 whether the comprising asset record A.REC.01-A.REC.N is available is currently assigned to a reservation request record REQ.01-REQ.N. The asset assigned/unassigned flag FLAG.A/U may be a simple binary digit or variable, wherein when the asset assigned/unassigned flag FLAG.A/U is in a first binary state the asset assigned/unassigned flag FLAG.A/U indicates that the comprising asset request A.REC.01-A.REC.N is currently assigned to a single identified reservation request record REQ.01-REQ.N, and alternately when the assigned/unassigned flag FLAG.A/U is in a second binary state the assigned/unassigned flag FLAG.A/U indicates that the comprising asset request A.REC.01-A.REC.N is currently not assigned to any reservation request record REQ.01-REQ.N.

An asset availability indicator IND.A/U indicates to the system 100 whether the comprising asset record A.REC.01-A.REC.N is available for automated assignment or reassignment to a record reservation request record REQ.01-REQ.N in the process of FIGS. 3 through FIG. 8. The asset availability indicator IND.A/U may be a simple binary digit or variable, wherein when the asset availability indicator IND.A/U is in a first binary state the asset availability indicator IND.A/U indicates that the comprising asset record A.REC.01-A.REC.N is available for assignment or reassignment by the system 100 to a reservation request REQ.01-REQ.N in an automated process and without further interaction by the system 100 with a human system administrator or other human operator of an information technology system (hereinafter, a “sys admin”), and alternately when the asset availability indicator IND.A/U is in an alternate second binary state the asset availability indicator IND.A/U indicates that the comprising asset record A.REC.01-A.REC.N is not available for assignment or reassignment to reservation request REQ.01-REQ.N by the system 100 in an automated process and without further interaction with the sys admin by the system 100.

It is understood that one or more asset records A.REC.01-A.REC.N may have none, one or more than one feature indicators AFEAT.01-N, wherein each unique feature indicator AFEAT.01-N associates a comprising asset record A.REC.01-A.REC.N with a particular aspect, quality or element that is not generally included within asset records having a same asset quality level AQL. It is understood that the null feature value F.NULL represents a data field that does not record feature indicator AFEAT.01-N.

In the invented method, an instant asset record A.REC.01-A.REC.N may be assigned to or with a reservation request record REQ.01-REQ.N by writing the asset identifier A.ID.01-A.ID.N comprised within the instant asset record A.REC.01-A.REC.N into a reservation request record REQ.01-REQ.N, selected by the system 100 or a sys admin, to establish an assignment of the instant asset record A.REC.01-A.REC.N to the selected reservation request record REQ.01-REQ.N. Optionally an optional assigned/unassigned request indicator flag R.FLAG.A/U.01-R.FLAG.A/U.N of the selected reservation request record REQ.01-REQ.N may be set to an indication of assigned.

Furthermore, in the invented method the instant asset record A.REC.01-A.REC.N may optionally be unassigned from a previously assigned reservation request record REQ.01-REQ.N by erasing the as previously written asset identifier A.ID.01-A.ID.N from the previously assigned reservation request record REQ.01-REQ.N. Optionally or additionally, an optional assigned/unassigned request indicator flag of R.FLAG.A/U.01-R.FLAG.A/U.N of the previously assigned reservation request record may be set to an indication of unassigned.

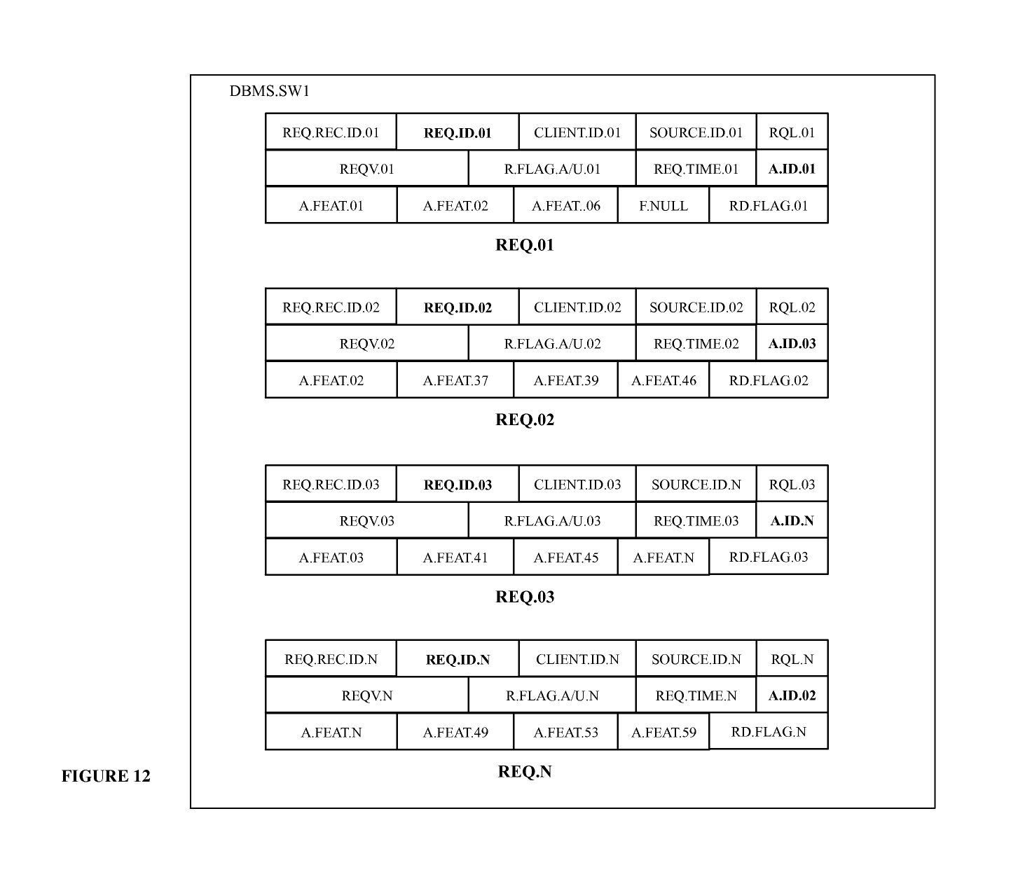

Referring now generally to the Figures and particularly to FIG. 3 and FIG. 12, FIG. 3 illustrates presents an exemplary first reservation request software record REQ.01 of a plurality reservation request records REQ.01-REQ.N. Each reservation request record REQ.01-REQ.N preferably includes a request record identifier REQ.REC.ID, a unique reservation request identifier REQ.ID that uniquely identifies a request for use of a virtual or physical asset, an optional requestor client identifier CLIENT.ID that identifies a requesting client, an optional request source identifier SOURCE.ID that identifies an agency or a an electronic message sender from whom the comprising request record REQ.01-REQ.N was received or is identified as an originator of the comprising request record REQ.01-REQ.N, a request quality level value RQL.01-RQL.N (hereinafter “request quality level RQL”), a reservation request valuation REQV.01-REQ.N, an assigned/unassigned request flag RFLAG.A/U, an associated requested time REQ.TIME, optionally a tentatively assigned asset identifier A.ID, and/or one or more optional requested asset feature identifiers A.FEAT.01-A.FEAT.N. It is understood that the asset identifier A.ID.01-A.ID.N held in one or more reservation request records REQ.01-REQ.N may be a temporary assignment that may be overwritten within each comprising request record REQ.01-REQ.N with alternate asset identifiers A.ID.01-A.ID.N one or more times within the process of the invented method. It is understood that one or more elements of one or more reservation request software records REQ.01-REQ.N may be blank or hold null values at, or within, one or more times or time periods of application of the invented method, e.g. when no an asset record A.REC.01-A.REC.N is assigned to a reservation request record REQ.01-REQ.N, the unassigned reservation request record REQ.01-REQ.N may include a null or blank value in request software record data field reserved to store an assigned asset identifier A.ID.01-A.ID.N.

It is noted the exemplary first asset record A.REC.01 and the exemplary first request record REQ.01 have the same three feature identifiers A.FEAT.01, A.FEAT.02 & AFEAT.06. It is understood that a feature match may therefore be discovered between the first asset record A.REC.01 and the exemplary first request record REQ.01 by the invented system 100 in accordance with certain alternate preferred embodiments of the invented method.

The inventive aspect of feature matching is not applied in certain alternate preferred embodiments of the method of the present invention. In addition, the inventive aspect of feature matching is applied by the system 100 as directed by the sys admin and/or by an automated determination by an applications software of the system 100.

Each assigned/unassigned request flag R.FLAG.A/U, indicates to the system 100 whether the comprising reservation request record REQ.01-REQ.N is currently assigned to an asset record A.REC.01-A.REC.N. The assigned/unassigned request flag R.FLAG.A/U may be a simple binary digit or variable, wherein when the assigned/unassigned request flag R.FLAG.A/U is in a first binary state the assigned/unassigned request R.FLAG.A/U indicates that the comprising reservation request record REQ.01-REC.N is currently assigned to a single identified asset record A.REC.01-A.REC.N, and alternately when the assigned/unassigned request flag R.FLAG.A/U is in a second binary state the assigned/unassigned request R.FLAG.A/U indicates that the comprising reservation request record REQ.01-REC.N is currently assigned to a single identified asset record A.REC.01-A.REC.N

Each request availability indicator R.IND.A/U indicates to the system 100 whether the comprising reservation request record REQ.01-REQ.N is available for automated assignment or reassignment to an asset record A.REC.01-A.REC.N in the process of FIGS. 3 through FIG. 8. The request availability indicator R.IND.A/U may be a simple binary digit or variable, wherein when the request availability indicator R.IND.A/U is in a first binary state the request availability indicator R.IND.A/U indicates that the comprising reservation record request REQ.01-REQ.N is available for assignment or reassignment by the system 100 in an automated process and without further interaction with by the system 100 with the sys admin, and alternately when the request availability indicator R.IND.A/U is in an alternate second binary state the request availability indicator R.IND.A/U indicates that the comprising reservation record request REQ.01-REQ.N is not available for assignment or reassignment to an asset record A.REC.01-A.REC.N by the system 100 in an automated process and without further interaction with the sys admin.

It is understood that one or more reservation request records REQ.01-REQ.N may have none, one or more than one feature indicators AFEAT.01-N, wherein each unique feature indicator AFEAT.01-N associates a comprising reservation request records REQ.01-REQ.N with a particular aspect, quality or element that is not generally included within asset records A.REC.01-A.REC.N. It is further understood that the null feature value F.NULL represents a data field that does not record feature indicator AFEAT.01-N.

The process of assigning a reservation request record REQ.01-REQ.N to an asset record A.REC.01-A.REC.N may include, or alternately consist of, writing a reservation request identifier REQ.01-REQ.N of the assigned reservation request record REQ.01-REQ.N into the assigned asset record A.REC.01-A.REC.N.

The process of assigning an asset record A.REC.01-A.REC.N to a reservation request record REQ.01-REQ.N may include, or alternately consist of, writing an asset identifier A.ID.01-A.ID.N of the assigned asset record A.REC.01-A.REC.N into the assigned reservation record REQ.01-REQ.N.

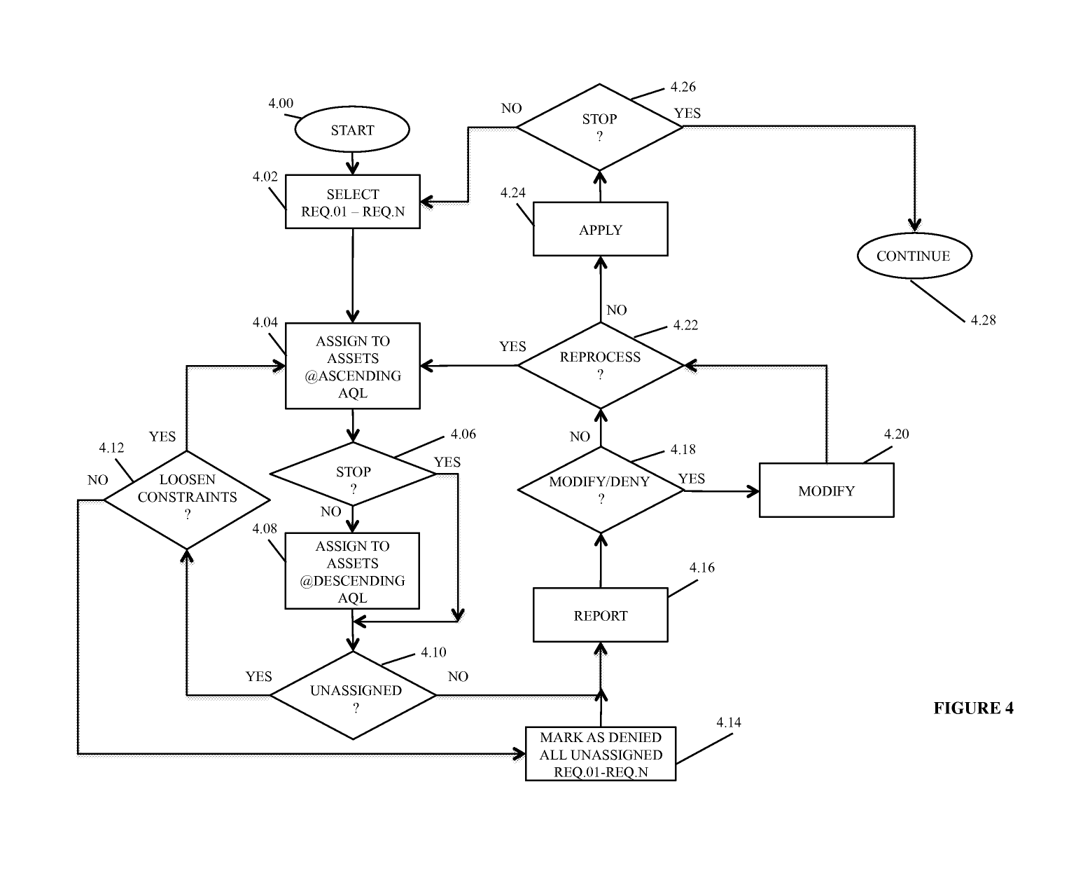

A reservation request REQ.01-REQ.N may be indicated as denied setting an internal request denied flag RD.FLAG.01-RDFLAG.N to a denied value, or i.e., a denied indication value. The request denied flag RD.FLAG may be a simple binary digit or variable, wherein when the request denied flag RD.FLAG is in a first binary state request denied flag RD.FLAG indicates that the reservation request record REC.01-REC.N comprising the instant request denied RD.FLAG is an open state and available for assignment to an asset record A.REC.01-A.REC.N and alternately when the request denied flag RD.FLAG is in a second binary state request denied flag RD.FLAG indicates to the system 100 that the comprising reservation request record REQ.01-REQ.N is denied and is not currently being considered for an assignment to any asset record A.REC.01-A.REC.N. The request denied flag RD.FLAG is preferably set by the sys admin at step 4.22, or at a time subsequent to step 4.22, of the process of FIG. 4.

In the invented method, a reservation request record REQ.01-REQ.N may be assigned to or with an asset record A.REC.01-A.REC.N by writing the request identifier REQ.ID.01-REQ.ID.N comprised within the instant reservation request record REQ.01-REQ.N into an asset record A.REC.01-A.REC.N, selected by the system 100 or a sys admin, to establish an assignment of the instant reservation request record REQ.01-REQ.N to the selected asset record A.REC.01-A.REC.N. Optionally an optional assigned/unassigned asset indicator flag FLAG.A/U.01-FLAG.A/U.N of the selected asset record A.REC.01-A.REC.N may be set to an indication of assigned.

Furthermore, in the invented method the instant reservation request record REQ.01-REQ.N may optionally be unassigned to a previously assigned asset record A.REC.01-A.REC.N by erasing the request identifier REQ.ID.01-REQ.ID.N previously written into the previously assigned asset record A.REC.01-A.REC.N from this previously assigned asset record A.REC.01-A.REC.N. Optionally or additionally, an optional assigned/unassigned asset indicator flag of FLAG.A/U.01-FLAG.A/U.N of the previously assigned asset record A.REC.01-A.REC.N may be set to an indication of unassigned.

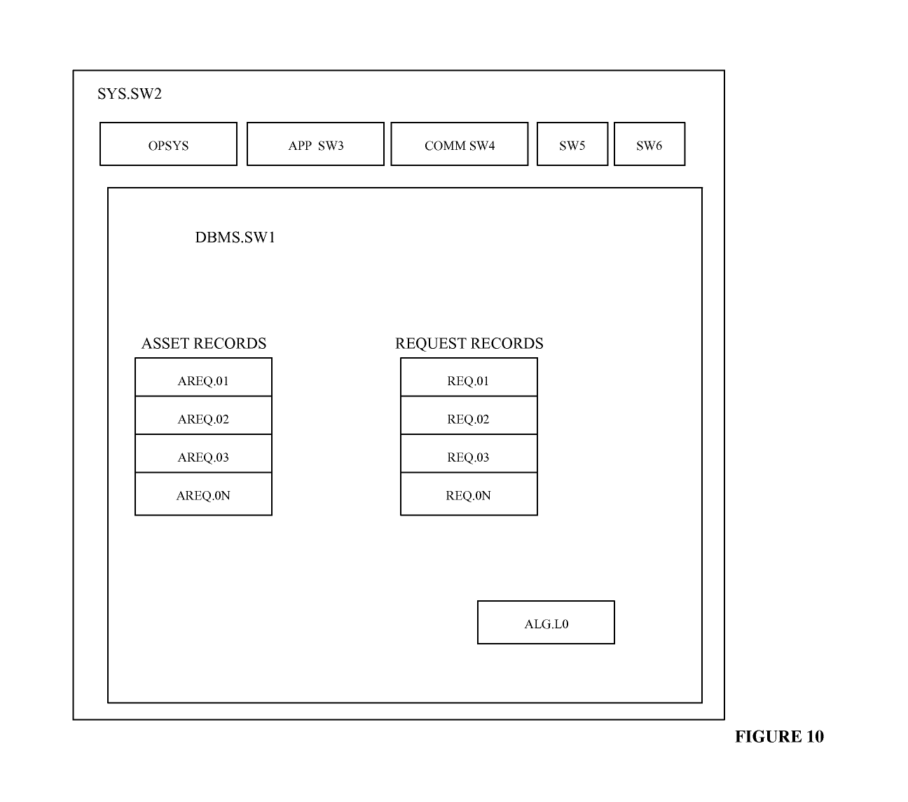

Referring now generally to the Figures and particularly to FIG. 4, FIG. 4 is a process chart of the first preferred embodiment of the invented method that may be effected by human interaction with the information technology system 100. In the first method a plurality of reservation requests REQ.01-REQ.N are received by the system 100 and tentatively or temporarily assigned and, often later reassigned, to individual hotel rooms, i.e., by writing to in selected asset identifiers A.ID.01-A.ID.N into reservation request records REQ.01-REQ.N in an exclusive, one-to-one basis, associated with the hotel in a performance of a first preferred embodiment of the invented method. In step 4.02 the plurality of reservation requests REQ.01-REQ.N REQ.N are selected that specify a same requested time REQ.TIME, wherein each selected reservation request REQ.01-REQ.N preferably requests an assignment of a hotel room for guest access on a same day and/or within an overlapping time period that comprises, or is comprised within, a same asset time value A.TIME. In the loop of steps 4.04 through 4.08 a system 100, as further discussed generally in the Figures and particularly FIGS. 9 and 10, attempts to uniquely assign a singular asset identifier A.ID.01-AD.N to each reservation request REQ.01-REQ.N on a one-to-one exclusive basis, wherein (a.) no asset identifier A.ID-A.ID.N is simultaneously comprised within or associated with more than one reservation request record REQ.01-REQ.N or associated with more than one request identifier REQ.ID.01-REQ.ID.N; and (b.) no request identifier REQ.ID.01-REQ.ID.N is simultaneously comprised within or associated with more than one asset record A.REC.01-AREC.N or associated with more than one asset identifier A.ID.01-A.ID.N.

The system 100 selects a plurality of reservation request records REQ.01-REQ.N having a same time value REQ.TIME. In step 4.02 and initiates assigning the selected plurality of reservation request records REQ.01-REQ.N to available asset records A.REC.01-A.REC.N having a matching time value A.TIME.

The system 100 preferably makes these assignments of available asset records A.REC.01-A.REC.N and available reservation request records REQ.01-REQ.N in step 4.04 on the basis of making temporary assignments of reservation requests records REQ.01-REQ.N to assets identifiers A.ID.01-A.ID.N first in ascending order of asset quality level values L0-L4, as denoted by asset quality levels AQL within each available asset records A.REC.01-A.REC.N.

When the system 100 determines in step 4.06, as directed by the sys admin or by an automated determination process, whether to continue on to step 4.08 or alternatively to execute step 4.10. In step 4.08 the selected plurality of reservation request records REQ.01-REQ.N may reassign available asset records A.REC.01-A.REC.N in a descending asset quality value from L4 to L0 as denoted by asset quality levels within each available asset records A.REC.01-A.REC.N.

The assignments and reassignments of the selected plurality of reservation request records REQ.01-REQ.N the plurality of available asset records A.REC.01-A.REC.N of steps 4.04 and 4.08 may optionally include and attempt to match reservation request records REQ.01-REQ.N with asset records A.REC.01-A.REC.N that share one or more feature designators A.FEAT.01-A.FEAT.N, i.e., applying feature matching as an aspect of selectively assigning reservation request records REQ.01-REQ.N to available asset records A.REC.01-A.REC.N on a one-to-one exclusive assignment basis.

It is understood that one or more reservation requests REQ.01-REQ.N may be tentatively reassigned in step 4.08 to an asset identifier A.ID.01-A.ID.N to which the instant reservation request REQ.01-REQ.N had previously been assigned.

In step 4.10 the system 100 determines whether any reservation request records REQ.01-REQ.N remain unassigned, and if any available reservation request records REQ.01-REQ.N are determined to be unassigned, i.e., a reservation request record REQ.01-REQ.N that is not comprising an asset identifier A.ID.01-A.ID.N, the system proceeds to step 4.12 and to determine whether remove or loosen assignment constraints as applied in the most recent execution of step 4.04. A removing or loosening assignment constraints of step 4.12 might include (a.) setting the asset availability indicator IND.A/U.01-IND.A/U.N in one or more asset records A.REC.01-A.REC.N from an unavailable indication to an available indication; (b.) setting the request availability indicator R.IND.A/U.01-RIND.A/U.N in one or more reservation request records REQ.01-REQ.N from an unavailable indication to an available indication; (c.) ceasing or limiting attempts to feature match the feature designators A.FEAT.01-A.FEAT.N as associated with asset records A.REC.01-A.REC.N and reservation request records REQ.01-REQ.N; and/or (d.) other suitable methods of loosening or removing reservation and asset assignments known in the art.

When the system 100 determines in step 4.12 that a previously applied constraint shall be removed, the system 100 (a.) optionally unassigns some or all previously assigned available asset records A.REC.01-A.REC.N and reservation request records REQ.01-REQ.N by removing asset identifiers A.ID.01-A.ID.N from reservation request records REQ.01-REQ.N and removing reservation request identifiers REQ.ID.01-REQ,ID.N from available asset records A.REC.01-A.REC.N; and (b.) proceeding onto a following execution of step 4.04.

In the alternative, when the system 100 determines in step 4.12 that a previously applied constraint shall not be removed, the system 100 proceeds onto step 4.14 and within each of the selected plurality of reservation request records REQ.01-REQ.N of step 4.02 sets the reservation denied flag RD.FLAG into the denied indication state. The system 100 proceeds from step 4.14 to step 4.16 and reports to the sys admin, or makes access available to the sys admin, the resultant assignments of available asset records A.REC.01-A.REC.N and reservation request records REQ.01-REQ.N as determined in one or more executions of steps 4.04 and/or step 4.08.

The sys admin may elect in step 4.18 to proceed onto step 4.20 and therein to (a.) modify one or more, or all, of the current assignments resultant assignments of available asset records A.REC.01-A.REC.N and reservation request records REQ.01-REQ.N in step; (b.) cancel any or all resultant assignments of available asset records A.REC.01-A.REC.N and reservation request records REQ.01-REQ.N of step 4.16 by setting the reservation denied flag RD.FLAG of one or more reservation request records REQ.01-REQ.N into the denied indication value; (c.) setting the asset availability indicator IND.A/U.01-IND.A/U.N in one or more asset records A.REC.01-A.REC.N from an unavailable indication to an available indication; and/or (d.) setting the request availability indicator R.IND.A/U.01-R.IND.A/U.N in one or more reservation request records REQ.01-REQ.N from an unavailable indication to an available indication.

The sys admin directs the system 100 in step 4.22 to either (a.) proceed to step 4.04 and to perform an additional execution of steps 4.04 through 4.22, i.e., reprocess and reassign the of the selected plurality of reservation request records REQ.01-REQ.N of the most recent execution of step 4.02, wherein the system 100 optionally unassigns some or all previously assigned available asset records A.REC.01-A.REC.N and reservation request records REQ.01-REQ.N by removing asset identifiers A.ID.01-A.ID.N from reservation request records REQ.01-REQ.N and removing reservation request identifiers REQ.ID.01-REQ,ID.N from available asset records A.REC.01-A.REC.N; or alternatively to step 4.24 and to apply the assignments available asset records A.REC.01-A.REC.N and reservation request records REQ.01-REQ.N to actually assign, and enable access of assets to requestors.

The system 100 proceeds from step 4.24 to step 4.26, wherein the sys admin may direct the system 100 to either (a.) proceed to step 4.02 and to perform an additional execution of steps 4.02 through 4.22; or proceed onto perform additional or alternative computational and/or communication operations of step 4.28.

The inventive aspect of feature matching is not applied in certain alternate preferred embodiments of the method of the present invention in the process of FIG. 4 through FIG. 8. In addition, the inventive aspect of feature matching is applied by the system 100 within the processes of FIG. 4 through FIG. 8 as directed by the sys admin and/or by an automated determination by an applications software of the system 100.

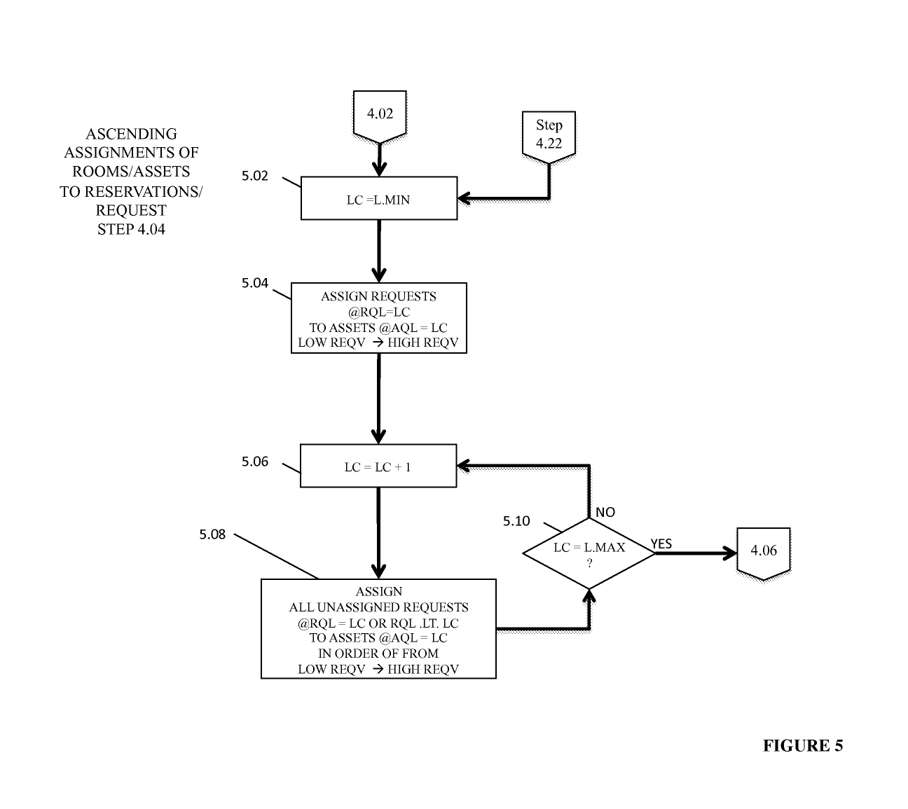

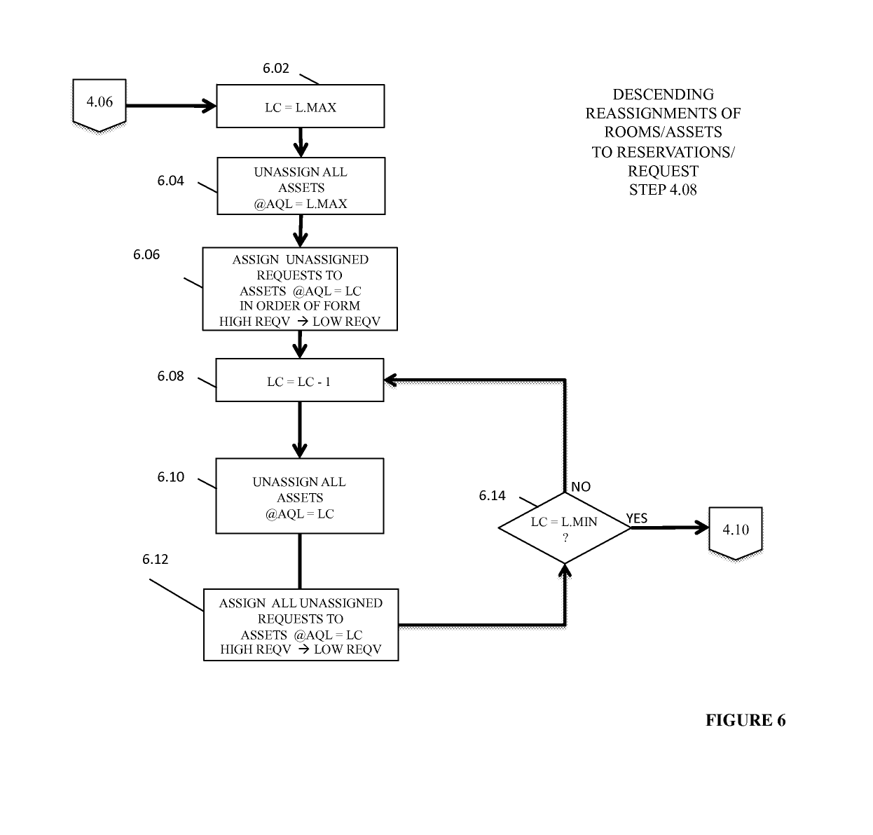

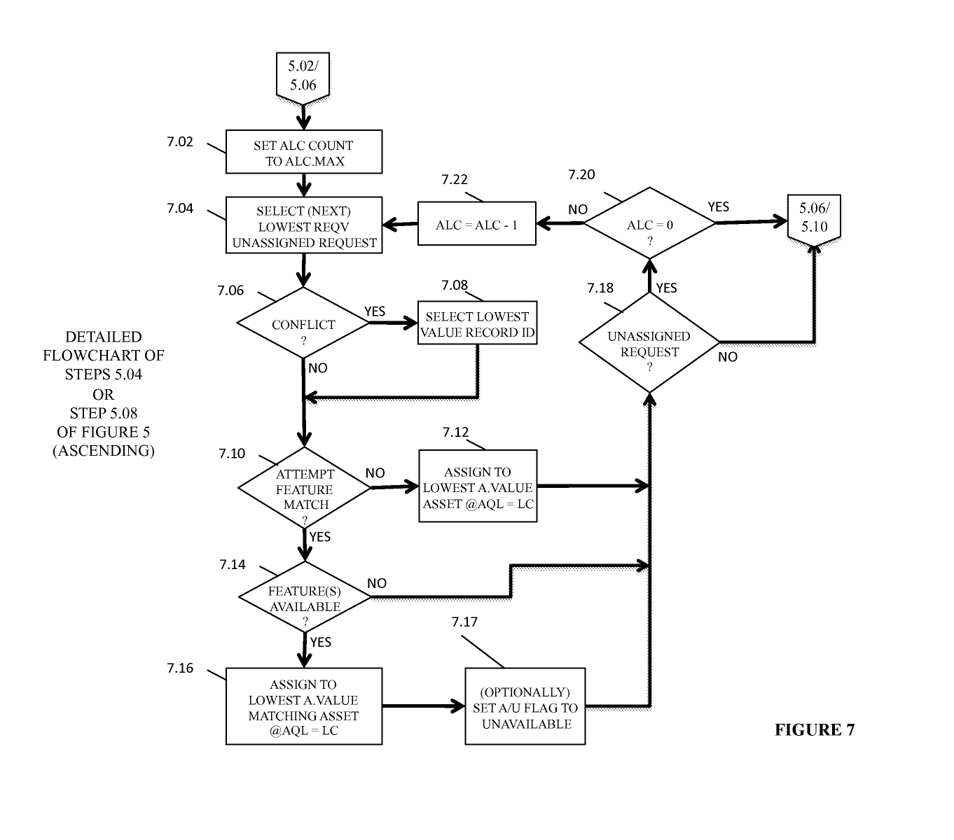

Referring now to FIG. 5, optional aspects of steps 4.04 are presented. It is understood that the system 100 proceeds from either step 4.02 or step 4.22 to step 5.02.

In step 5.02 a level counter LC is set to a minimum level value L.MIN of, e.g. a numerical zero value. In step 5.04 each available unassigned reservation request record REQ.01-REQ.N having a request quality level RQL equal to the loop counter value of L.MIN are considered for assignment to any available unassigned asset record A.REC.01-A.REC.N having an asset quality level AQL equal to the loop counter value of L.MIN, wherein the unassigned reservation request records REQ.01-REQ.N are assigned in a preferential, one-to-one order of from lowest request value REQV to highest request value REQV. The determination by the system 100 of whether an asset record A.REC.01-A.REC.N is available is based on the availability status of the asset availability indicator IND.A/U included in the instant asset record A.REC.01-A.REC.N at the time of execution of step 5.04. The determination by the system 100 of whether a reservation request record REQ.01-REQ.N is available is based on the availability status of the unavailable request indicator R.IND.A/U included in each reservation request record REQ.01-REQ.N at the time of execution of step 5.04.

The assigning process continues until either (a.) all available unassigned reservation request records REQ.01-REQ.N having a request quality level RQL equal to the loop counter value of L.MIN are assigned to an available asset record A.REC.01-A.REC.N having an asset quality level AQL equal to the loop counter value of L.MIN; or (b.) all available asset records A.REC.01-A.REC.N having an asset quality level AQL equal to the loop counter value of L.MIN are uniquely assigned to a singular and distinguishable reservation request record REQ.01-REQ.N having a request quality level RQL equal to the loop counter value of L.MIN.

The system 100 proceeds from step 5.04 to step 5.06 and. to increment the loop counter value LC, and from step 5.06 to step 5.08.

In step 5.08, each available unassigned reservation request record REQ.01-REQ.N having a request quality level RQL equal to or less than the loop counter value LC is considered for assignment to any available unassigned asset record A.REC.01-A.REC.N having an asset quality level AQL equal to the loop counter value LC, wherein the unassigned reservation request records REQ.01-REQ.N are assigned in a preferential, one-to-one order of from lowest request value REQV to highest request value REQV. The determination by the system 100 of whether an asset record A.REC.01-A.REC.N is available is based on the availability status of the asset availability indicator IND.A/U included in the instant asset record A.REC.01-A.REC.N at the time of execution of step 5.08. The determination by the system 100 of whether a reservation request record REQ.01-REQ.N is available is based on the availability status of the unavailable request indicator R.IND.A/U included in each reservation request record REQ.01-REQ.N at the time of execution of step 5.08.

The assigning process continues until either (a.) all available unassigned reservation request records REQ.01-REQ.N having a request quality level RQL equal to or less than the loop counter value LC are assigned to an asset record A.REC.01-A.REC.N having an asset quality level AQL equal to the loop counter value LC; or (b.) all asset records A.REC.01-A.REC.N having an asset quality level AQL equal to the loop counter value of L.MIN are uniquely assigned to a singular and distinguishable reservation request record REQ.01-REQ.N having a request quality level RQL equal to or less than the loop counter value of L.MIN.

Each execution of the loop of steps 5.06 through 5.10 ends when the loop counter LC is found in an execution of step 5.10 to equal or exceed the L.MAX value, e.g., level 4 of the instant example, of the quality level room listing 102, whereupon the system 100 proceeds from step 5.10 to step 4.06 of the process of Figure.

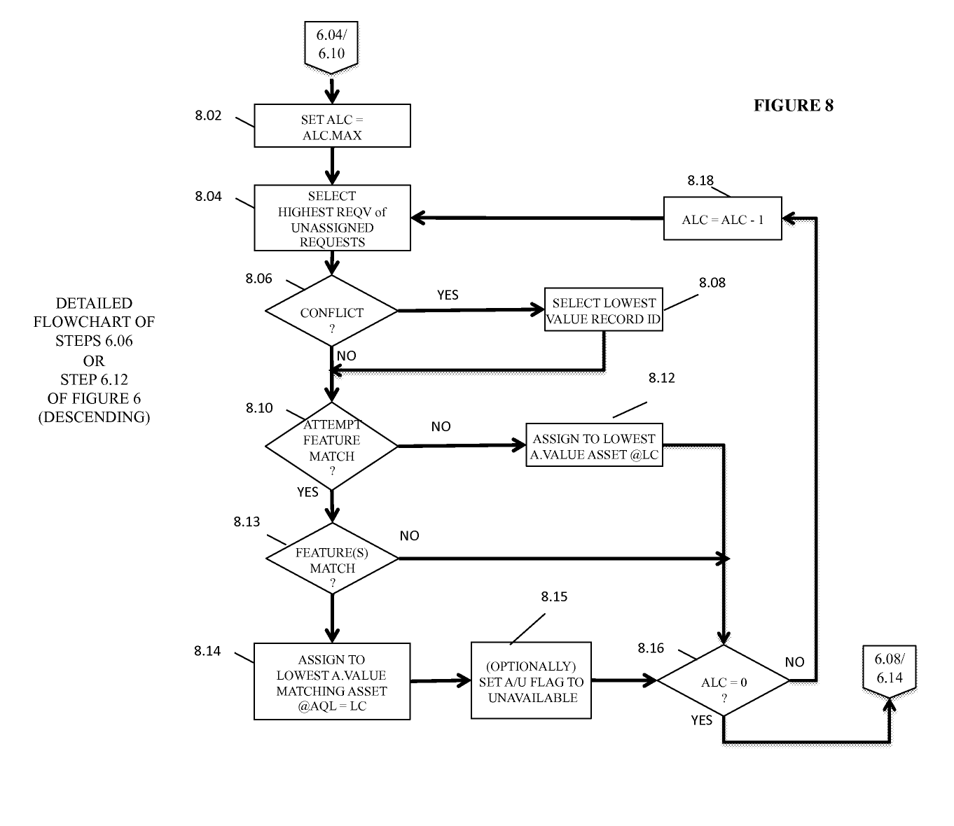

Referring now to FIG. 6, optional aspects of step 4.08 of FIG. 4 are presented. The system 100 proceeds from step 4.06 to step 6.02 as determined by an automated instruction and/or in response to direction by a sys admin.

In step 6.02 the level counter LC is set to a maximum quality level value L.MAX, i.e., a numerical value of four in the instant example, and in step 6.04 all available asset records A.REC.01-A.REC.N having an asset quality level AQL equal to the maximum quality level value L.MAX are unassigned from any reservation requests record REQ.01-REQ.N.

In step 6.06, each available unassigned reservation request record REQ.01-REQ.N is considered for assignment to any available unassigned asset record A.REC.01-A.REC.N having an asset quality level AQL equal to the loop counter value L.MAX, wherein the unassigned reservation request records REQ.01-REQ.N are assigned in a preferential, one-to-one order of from highest request value REQV to lowest request value REQV. The assigning process continues until either (a.) all available unassigned reservation request records REQ.01-REQ.N are assigned to an asset record A.REC.01-A.REC.N having an asset quality level AQL equal to the loop counter value L.MAX; or (b.) all available asset records A.REC.01-A.REC.N having an asset quality level AQL equal to the loop counter value of L.MAX are uniquely assigned to a singular and distinguishable available reservation request record REQ.01-REQ.N.

The determination by the system 100 of whether an asset record A.REC.01-A.REC.N is available is based on the availability status of the asset availability indicator IND.A/U included in the instant asset record A.REC.01-A.REC.N at the time of execution of step 6.06. The determination by the system 100 of whether a reservation request record REQ.01-REQ.N is available is based on the availability status of the unavailable request indicator R.IND.A/U included in each reservation request record REQ.01-REQ.N at the time of execution of step 6.06.

The system 100 proceeds from step 6.06 to step 6.08 and to decrement the loop counter LC and therefrom to step 6.10.

In step 6.10 all asset records A.REC.01-A.REC.N having an asset quality level AQL equal to the loop counter value LC are unassigned from any reservation requests record REQ.01-REQ.N.

In step 6.12, each available previously unassigned reservation request record REQ.01-REQ.N is considered for assignment to any available unassigned asset record A.REC.01-A.REC.N having an asset quality level AQL equal to the loop counter value LC, wherein the unassigned reservation request records REQ.01-REQ.N are assigned in a preferential, one-to-one order of from highest request value REQV to lowest request value REQV. The assigning process continues until either (a.) all available unassigned reservation request records REQ.01-REQ.N are assigned to an asset record A.REC.01-A.REC.N having an asset quality level AQL equal to the loop counter value LC; or (b.) all available asset records A.REC.01-A.REC.N having an asset quality level AQL equal to the loop counter value of LC are uniquely assigned to a singular and distinguishable reservation request record REQ.01-REQ.N.

The determination by the system 100 of whether an asset record A.REC.01-A.REC.N is available is based on the availability status of the asset availability indicator IND.A/U included in the instant asset record A.REC.01-A.REC.N at the time of execution of step 6.12. The determination by the system 100 of whether a reservation request record REQ.01-REQ.N is available is based on the availability status of the unavailable request indicator R.IND.A/U included in each reservation request record REQ.01-REQ.N at the time of execution of step .6.12

When the system determines in step 6.14 after an execution of step 6.12 that the loop counter value LC has achieved the lowest quality level, i.e. L.MIN, the system 100 proceeds on to step 4.10 of the process of FIG. 4.

Referring now generally to the Figures and particularly to FIG. 7, FIG. 7 is a representation of optional aspects of steps 5.04 and 5.08 of FIG. 5.

In step 7.02 a maximum available an available asset loop counter ALC is set equal to number of available asset records A.REC.01-A.REC.N having an asset quality level AQL equal to the loop counter value LC. As stated previously, the determination by the system 100 of whether an asset record A.REC.01-A.REC.N is available is based on the availability status of the asset availability indicator IND.A/U included in the instant asset record A.REC.01-A.REC.N at the time of execution of step 7.02.

The system 100 then loops through steps 7.04 through 7.22 until either (a.) no unassigned reservations requests REQ.01-REQ.N are found to be available in step 7.18, i.e., the asset loop counter ALC has been decremented to a zero or lowest value; or (b.) the value of the asset loop counter ALC is found to be at or below a zero value or at a null level in an execution of step 7.20, wherein the system 100 determines that there are no extant unassigned and available asset records A.REC.01-A.REC.N at the asset quality level AQL equal to the current value of the loop counter LC. As per step 7.04, the available unassigned reservation request REQ.01-REQ.N having the lowest request value REQV is selected for assignment in the following execution of the loop of steps 7.04 through 7.22. It is understood that the loop of steps 7.06 and 7.08 resolve conflicts of reservation record requests REQ.01-REQ.N having equal request values REQV by comparing an arbitrary numerical valuation of the instant reservation record identifiers REQ.REC.ID.

In optional step 7.10 the system 100 determines whether or not to attempt to feature match the reservation request record REQ.01-REQ.N selected in the lost recent execution of step 7.04 to an available unassigned asset record A.REC.N having an asset quality level AQL equal to the current loop counter value LC. It is understood that in certain alternate preferred embodiments of the invented method that steps 7.10 through 7.17 are not provided and that the system 100 simply proceeds from step 7.06 to step 7.14

It is further understood that the optional steps 7.12 through 7.17 the system 100 selects and assign reservation requests REQ.01-REQ.N alternatively on a possible determination of a feature match in step 7.12 between one or more requested asset features A.FEAT.01-A.FEAT.N of a reservation request record REQ.01-REQ.N and as noted in an available asset record A.REC.01-A.REC.N. When the system 100 determines in step 7.12 that there is a feature match can not be determined between the currently selected reservation request record REQ.01-REQ.N as selected in the most recent execution of step 7.04 and any available asset record A.REC.01-A.REC.N having an asset quality level AQL equal to the current loop counter value LC, the system proceeds from step 7.12 to step 7.18. It is understood that when the system 100 proceeds from step 7.12 to step 7.18 without assigning the currently selected reservation request record REQ.01-REQ.N as selected in the most recent execution of step 7.04, that the instant reservation request record REQ.01-REQ.N will not again be considered for assignment to an asset record A.REC.01-A.REC.N in the current execution of the loop of steps 7.02 through 7.22.

In the alternative, when a feature match is determined in step 7.12, the system 100 assigns the currently selected reservation request record A.REC.01-A.REC.N to the feature matching asset record A.REC.01-A.REC.N having the lowest asset value A.VALUE.01-A.VALUE.N.

In optional step 7.17, the asset availability flag FLAG.A/U.01-FLAG.A/U.N of the asset record A.REC.01-A.REC.N assigned in the most recent execution of step 7.16 and/or the request availability flag R.FLAG.A/U.01-R.FLAG.A/U.N of the reservation request record REQ.01-REQ.N also assigned in the in the most recent execution of step 7.16 may be set to an unavailable indication. The settings of these availability flags FLAG.A/U.01-FLAG.A/U.N & R.FLAG.A/U.01-R.FLAG.A/U.N may optionally inhibit the system 100 from unassigning or reassigning the comprising asset record A.REC.01-A.REC.N or comprising reservation request record REQ.01-REQ.N respectively in future iterations of the process of FIGS. 4 through 8 absent action by the system 100 or the sys admin in steps 4.12 and/or 4.20.

In one example of a possible feature match finding by the system 100, the exemplary first request record REQ.01 is laden with the same three feature identifiers A.FEAT.01, A.FEAT.02 & AFEAT.06 as the exemplary first asset record A.REC.01, whereby if these two records were available and unassigned at the time of execution of step 7.12, the system 100 would assign the exemplary first request record REQ.01 to the exemplary first asset record A.REC.01 in step 7.16 if there were no lower valued available asset records A.REC.02-A.REC.N from the plurality of asset records A.REC.01-A.REC.N selected in accordance with the method of FIG. 5.

The determinations of steps 7.18 or step 7.20 may be made by the system 100 on an automated basis and/or in response to direction by a sys admin, whereby the system may proceed from either step 7.18 or step 7.20 to step 5.06 or 5.10 of the process of FIG. 5. The asset loop counter ALC is decremented in each execution of step 7.22.

It is understood that in an iteration of the method of FIG. 7 wherein the system 100 proceeds from step 5.02 to step 7.02, that the system 100 will exit the loop of step 7.02 to step 7.22 by proceeding to an execution of step 5.06. It is further understood that in an iteration of the method of FIG. 7 wherein the system 100 proceeds from step 5.06 to step 7.02, that the system 100 will exit the loop of step 7.02 to step 7.22 by proceeding to an execution of step 5.10.

Referring now generally to the Figures and particularly to FIG. 8, FIG. 8 is a representation of optional aspects of steps 6.06 and 6.12 of FIG. 6. In step 8.02 the maximum available asset loop counter ALC is set equal to number of available asset records A.REC.01-A.REC.N having an asset quality level AQL equal to the loop counter value LC. The determination of whether an asset record A.REC.01-A.REC.N is available is based on the availability status of the asset availability indicator IND.A/U included in the instant asset record A.REC.01-A.REC.N at the time of execution of step 7.02.

The system 100 after step 8.02 then loops through steps 8.04 through 8.18 until The value of the asset loop counter ALC is found to be at or below a zero or null level in an execution of step 8.16, wherein the system 100 determines that there are no extant unassigned and available asset records A.REC.01-A.REC.N at the asset quality level AQL equal to the current value of the loop counter LC. As per step 8.04, the available unassigned reservation request REQ.01-REQ.N having the highest request value REQV is selected for assignment in the following execution of the loop of steps 8.04 through 8.18. It is understood that the loop of steps 8.06 and 8.08 resolve conflicts of reservation record requests REQ.01-REQ.N having equal request values REQV by comparing an arbitrary numerical valuation of the instant reservation record identifiers REQ.REC.ID.

It is further understood that the optional steps 8.13, 8.14 and 8.15 select and assign reservation requests REQ.01-REQ.N alternatively on a determination of a feature match between one or more requested asset features A.FEAT.01-A.FEAT.N of a reservation request record REQ.01-REQ.N and as noted in an available asset record A.REC.01-A.REC.N.

In one example of a possible feature match finding by the system 100, the exemplary first request record REQ.01 is laden with the same three feature identifiers A.FEAT.01, A.FEAT.02 & AFEAT.06 as the exemplary first asset record A.REC.01, whereby if these two records were available and unassigned at the time of execution of step 8.10, the system 100 would assign the exemplary first request record REQ.01 to the exemplary first asset record A.REC.01 in step 8.14 if there were no lower valued available asset records A.REC.02-A.REC.N from the plurality of asset records A.REC.01-A.REC.N selected in accordance with the method of FIG. 6.

In optional step 8.15 the system 100 may set the availability/unavailability asset indicator IND.A/U.01 to the unavailable setting and/or the availability/unavailability request indicator IND.A/U.01 to the unavailable setting.

The determinations of step 8.14 may be made by the system 100 on an automated basis and/or in response to direction by a sys admin, whereby the system may proceed from either step 8.14 to step 6.08 or step 6.14 of the process of FIG. 6. The asset loop counter ALC is decremented in each execution of step 8.18. It is understood that in cases where optional step 8.13 is attempted to determine a feature match, and no feature match is detected, that the system 100 proceeds from step 8.13 to step 8.16. It is further understood that in certain alternate preferred embodiments of the invented method that the optional steps 8.10, 8.13, 8.14 and 8.15 are neither executed nor instantiated, and that the system 100 proceeds from step 8.06 to step 8.12. In step 8.12 the system 100 assigns the currently selected reservation request record REQ.01-REQ.N to the available and unassigned asset record A.REC.01-A.REC.N to having the lowest asset value A.VALUE.01-A.VALUE.N

It is also understood that in an iteration of the method of FIG. 8 wherein the system 100 proceeds from step 6.04 to step 8.02, that the system 100 will exit the loop of step 8.02 to step 8.18 by proceeding to an execution of step 6.08 upon the next succeeding finding in an execution of step 8.16 that the loop counter ALC is equal to or less than zero or a null value. It is further understood that in an iteration of the method of FIG. 8 wherein the system 100 proceeds from step 6.10 to step 8.02, that the system 100 will exit the loop of step 8.02 to step 8.18 by proceeding to an execution of step 6.14 upon the next succeeding finding in an execution of step 8.16 that the loop counter ALC is equal to or less than zero or a null value.

Referring now generally to the Figures and particularly to FIG. 9, FIG. 9 is a schematic block diagram of the system 100. The system 100 includes a central processing unit module 902 (hereinafter, “CPU” 902) that may comprise one or more logic processors. The CPU 902 is bi-directionally communicatively coupled by an internal communications bus 904 to a user input module 906, a display module 908, a network communications interface module 910 and a system memory 912. The user input module 906 is adapted to enable the sys admin or other human operator to direct the system 100 in accordance with the invented method. The display module 908 is adapted to enable system 100 to visually display to the sys admin or other human operator data, status and instructions in accordance with the invented method, to include the contents of data base management system DBMS SW1 and other information stored in the memory 912 and/or provided to the system 100 via the network interface 910. The network interface 910 bi-directionally communicatively couples the system 100 to an electronics communications network 914. The DBMS SW.1 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; an Advantage Database Server™ relational database management system as marketed by Sybase, Inc. of Dublin, Calif., or other suitable database management software known in the art. It is understood that the electronics communications network 914 may be or comprise the Internet, a telephony network, and/or more computer electronics communications network.

The system 100 may be or comprise a bundled hardware and software informational technology system including but not limited to(a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7 ™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7 ™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable mobile electronic device, wireless communications device, computational system or electronic communications device known in the art.

Referring now generally to the Figures and particularly to FIG. 10, FIG. 10 is a block diagram of the system software SYS.SW2 of the system 100. The system software SYS.SW2 resident in the system 100 enables instantiation of the invented method of FIG. 4 through 8 in interaction with a sys admin. The system software SYS.SW2 includes the database management system SW1, an operating system OPSYS, an applications software APP.SW3, a communications software SW4, an input module driver software SW5, and a display module driver software SW6. The applications software APP.SW3 enables and directs the system 100 to practice the aspects of the invented method as disclosed in the Figures and accompanying text. The communications software SW4 enables the system 100 to receive, read and store reservation request records REQ.01-REQ.N from the network 914. The an input module driver software SW5 enables the system 100 to operate the input module 906 to allow the sys admin or other human operator to direct the system 100 in accordance with the invented method. The display module driver software SW6 enables the system 100 to operate the display module 908 to visually display to the sys admin or other human operator data, status and instructions in accordance with the invented method.

Referring now generally to the Figures and particularly to FIG. 11, FIG. 11 is a detailed block diagram illustrating the contents of four exemplary asset records A.REC.01, A.REC.02, A.REC.03 AND A.REC.N as stored in the database software DBMS SW1. FIG. 11 indicates that the first asset record A.REC.01 is assigned to the first reservation request record REQ.01 by inclusion of the first reservation request identifier REQ.ID.01 within the first asset record A.REC.01. FIG. 11 also indicates that the second asset record A.REC.02 is assigned to the Nth reservation request record REQ.N by inclusion of the Nth reservation request identifier REQ.ID.N within the second asset record A.REC.02. FIG. 11 further indicates that the third asset record A.REC.03 is assigned to the second reservation request record REQ.02 by inclusion of the second reservation request identifier REQ.ID.02 within the third asset record A.REC.03. FIG. 11 additionally indicates that the Nth asset record A.REC.N is assigned to the third reservation request record REQ.03 by inclusion of the third reservation request identifier REQ.ID.03 within the Nth asset record A.REC.N.

Referring now generally to the Figures and particularly to FIG. 12, FIG. 12 is a detailed block diagram illustrating the contents of four exemplary reservation request records REQ.01, REQ.02, REQ.03 AND REQ.N as stored in the database software DBMS SW1. FIG. 12 indicates that the first reservation request record REQ.01 is assigned to the first asset record A.REC.01 by inclusion of the first asset identifier A.ID.01 within the first reservation request record REQ.01. FIG. 12 also indicates that the second reservation request record REQ.02 is assigned to the third asset record A.REC.03 by inclusion of the third asset identifier A.ID.03 within the second reservation request record REQ.02. FIG. 12 also indicates that the third reservation request record REQ.03 is assigned to the Nth asset record A.REC.N by inclusion of the Nth asset identifier A.ID.N within the third reservation request record REQ.03. FIG. 12 additionally indicates that the Nth reservation request record REQ.N is assigned to the second asset record A.REC.02 by inclusion of the second asset identifier A.ID.02 within the Nth reservation request record REQ.N.

It is noted that each reservation request record REQ.01-REQ.N preferably includes a single internal dedicated request denial flag RD.FLAG.01-RD.FLAG.N that by its current value indicates whether the comprising reservation request record REQ.01-REQ.N is a denied state or a not denied state.

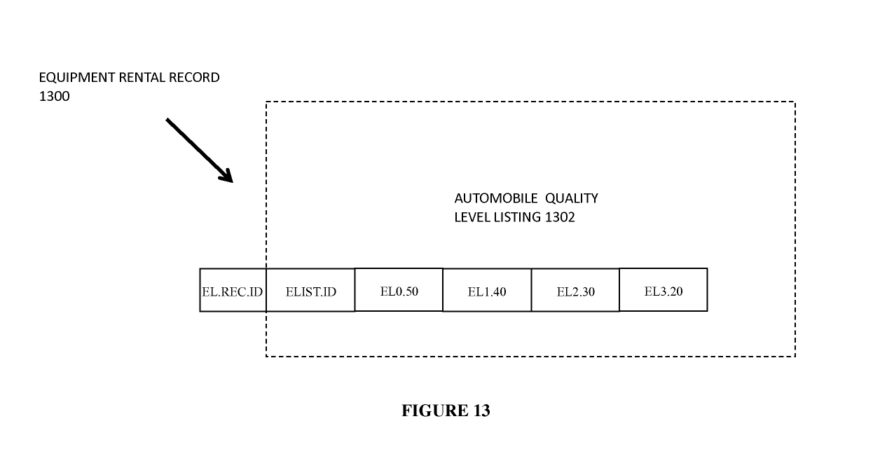

Referring now generally to the Figures and particularly to FIG. 13 and FIG. 9, FIG. 13 is a representation of an equipment rental record 1300 comprising an automobile asset quality level listing 1302 (hereinafter “the auto listing” 1302) stored within the system 100, wherein each of asset quality levels L0-L3 has a specified numerical count of available automobiles (hereinafter, “autos”). The auto listing 1302 further presents that an associated auto rental agency as including 50 autos at the first asset quality level L0, 40 autos at the second asset quality level L1, 30 autos at the third asset quality level L2, and 20 autos at the fourth asset quality level L3. These asset quality level counts, e.g., a count of 50 at the first and lowest asset quality level L0 and a count or 20 at the fourth and highest asset quality level of L3, of available autos at each respective asset quality level L0-L3 may be used in the invented method in one or more loops of assignments of equipment reservation requests EREQ.01E-REQ.N within each related quality level L0-L3.

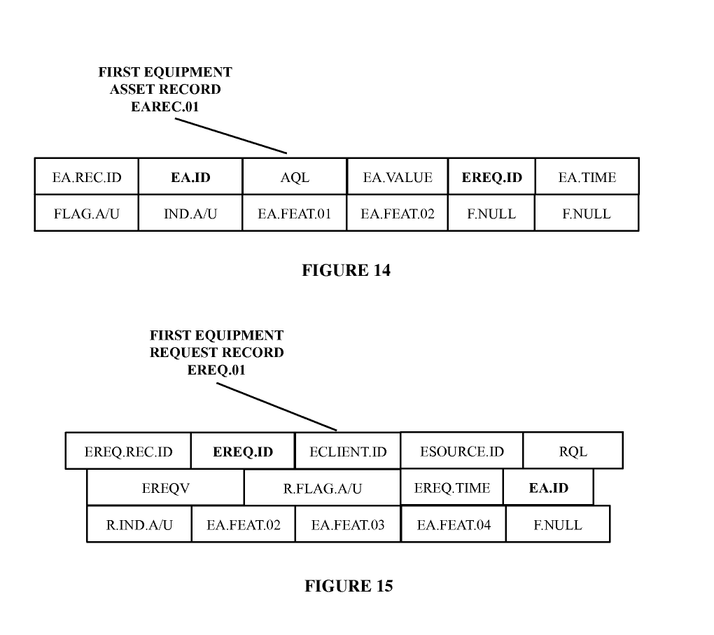

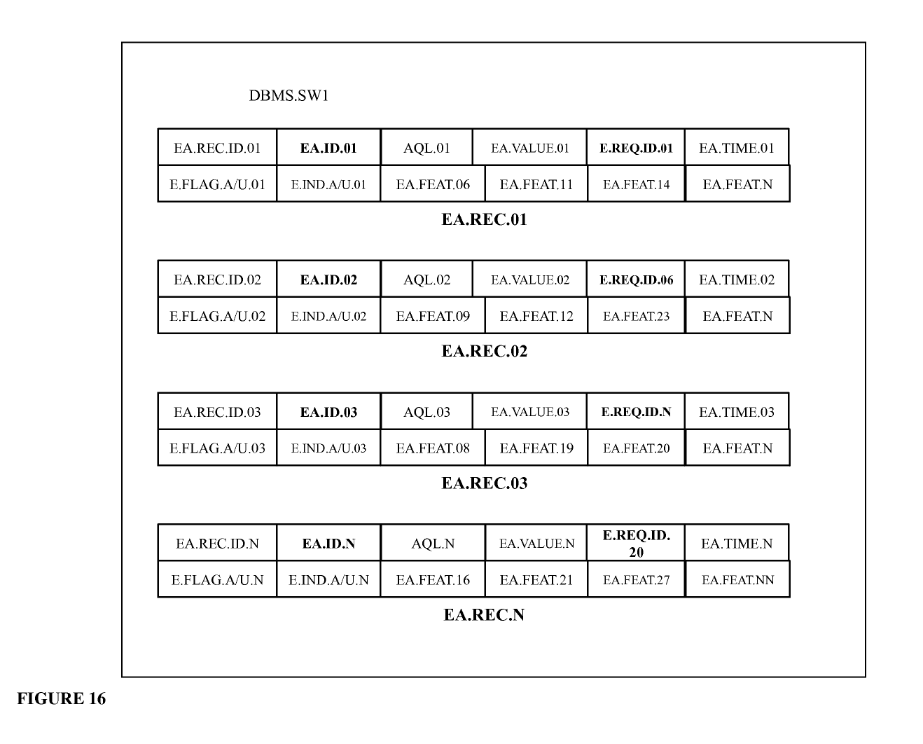

Referring now generally to the Figures and particularly to FIG. 14 and FIG. 16, FIG. 14 illustrates an exemplary first equipment asset record EA.REC.01 of a plurality of equipment asset records EA.REC.01-EA.REC.N that is additionally preferably stored in the system 100. Each equipment asset record EA.REC.01-A.REC.N preferably includes a unique equipment asset record identifier EA.REC.ID, a unique equipment asset identifier EA.ID that identifies an actually existing automobile, an equipment asset quality level designator AQL of the automobile identified by the equipment asset identifier EA.ID of the same equipment asset record EA.REC.01-EA.REC.N, an optional equipment asset value EA.VALUE, optionally an auto rental request identifier EREQ.ID of a tentatively assigned auto rental request record EREQ.ID.01-EREQ.N, an associated time period or instance A.TIME, an assigned/unassigned FLAG.A/U, an equipment asset availability indicator IND.A/U, and/or one or more optional one or more optional requested equipment asset equipment feature identifiers EA.FEAT.01-EA.FEAT.N. It is understood that one or more elements of one or more equipment asset records EA.REC.01-EA.REC.N may be blank or hold null values at, or within, one or more times or time periods of application of the invented method, e.g. when no auto rental request record EREQ.01-EREQ.N is assigned to an equipment asset record EA.REC.01-A.REC.N, the unassigned equipment asset record EA.REC.01-EA.REC.N may include a null or blank value in a data field reserved to tentatively store an auto rental request identifier EREQ.ID.

Each equipment asset assigned/unassigned FLAG.A/U, indicates to the system 100 whether the comprising equipment asset record EA.REC.01-A.REC.N is available is currently assigned to an auto rental request record EREQ.01-EREQ.N.

An equipment asset availability indicator IND.A/U indicates to the system 100 whether the comprising equipment asset record EA.REC.01-EA.REC.N is available for automated assignment or reassignment to a record car rental request record EREQ.01-EREQ.N in the process of FIGS. 3 through FIG. 8.

It is understood that one or more equipment asset records EA.REC.01-EA.REC.N may have none, one or more than one equipment feature indicators EAFEAT.01-N, wherein each unique feature indicator EAFEAT.01-N associates a comprising equipment asset record EA.REC.01-A.REC.N with a particular aspect, quality or element that is not generally included within equipment asset records having a same equipment asset quality level AQL. It is understood that the null feature value F.NULL represents a data field that does not record feature indicator EAFEAT.01-N.

It is understood that in various alternate preferred embodiments of the invented method that one or more asset record A.REC.01-A.REC.N or equipment asset records EA.REC.01-EA.REC.N may represent access to, rental of, usage of, and/or control of a time constrained asset, a time delineated service, a time period of service, an equipment, sets of equipment, one or more objects, venues, facilities, digitally stored data, documents, and/or time lengths of availability, access, usage, service and/or presence.

a hotel room, a rental vehicle, a venue seat, an airplane, an airplane seat during a flight, an event space, a transportation capacity unit, a service provider's time, or an equipment of which access to or usage of is time constrained.

Referring now generally to the Figures and particularly to FIG. 15 and FIG. 12, FIG. 15 illustrates presents an exemplary first auto rental request software record EREQ.01 of a plurality auto rental request records EREQ.01-EREQ.N. Each auto rental request record EREQ.01-EREQ.N preferably includes a request record identifier EREQ.EREC.ID, a unique auto rental identifier E.ID that uniquely identifies an issued request for use of an automobile, an optional requestor client identifier CLIENT.ID that identifies a requesting client, an optional request source identifier SOURCE.ID that identifies an agency or a an electronic message sender from whom the comprising auto rental request record EREQ.01-EREQ.N was received or is identified as an originator of the comprising request record EREQ.01-EREQ.N, an asset level request quality level RQL.01-RQL.N, an auto rental valuation EREQV.01-EREQ.N, an assigned/unassigned request flag ERFLAG.A/U, an associated requested time EREQ.TIME, optionally a tentatively assigned equipment identifier EA.ID, and/or one or more optional requested asset feature identifiers EA.FEAT.01-EA.FEAT.N. It is understood that the asset identifier EA.ID.01-EA.ID.N held in one or more auto rental request records EREQ.01-EREQ.N may be a temporary assignment that may be overwritten with the comprising request record EREQ.01-EREQ.N by alternate asset identifiers EA.ID.01-EA.ID.N one or more times within the process of the invented method. It is understood that one or more elements of one or more auto rental software records EREQ.01-EREQ.N may be blank or hold null values at, or within, one or more times or time periods of application of the invented method, e.g. when no an asset record EA.REC.01-EA.REC.N is assigned to a auto rental request record EREQ.01-EREQ.N, the unassigned auto rental request record EREQ.01-EREQ.N may include a null or blank value in request software record data field reserved to store an assigned asset identifier EA.ID.01-EA.ID.N.

It is noted the exemplary first equipment record EA.REC.01 and the exemplary first auto rental request record EREQ.01 have the same three feature identifiers EA.FEAT.01, EA.FEAT.02 & EAFEAT.06. It is understood that a feature match may therefore be discovered between the first auto asset record EA.REC.01 and the exemplary first auto rental record EREQ.01 by the invented system 100 in accordance with certain alternate preferred embodiments of the invented method.

Each assigned/unassigned request flag R.FLAG.A/U, indicates to the system 100 whether the comprising auto rental request record EREQ.01-EREQ.N is currently assigned to an asset record EA.REC.01-EA.REC.N. The assigned/unassigned request flag R.FLAG.A/U may be a simple binary digit or variable, wherein when the assigned/unassigned request flag R.FLAG.A/U is in a first binary state the assigned/unassigned request R.FLAG.A/U indicates that the comprising auto rental request record EREQ.01-EREC.N is currently assigned to a single identified asset record EA.REC.01-EA.REC.N, and alternately when the assigned/unassigned request flag R.FLAG.A/U is in a second binary state the assigned/unassigned request R.FLAG.A/U indicates that the comprising auto rental request record REQ.01-REC.N is currently assigned to a single identified asset record A.REC.01-A.REC.N

Each request availability indicator R.IND.A/U indicates to the system 100 whether the comprising auto rental request record REQ.01-REQ.N is available for automated assignment or reassignment to an asset record A.REC.01-A.REC.N in the process of FIGS. 3 through FIG. 8. The request availability indicator R.IND.A/U may be a simple binary digit or variable, wherein when the request availability indicator R.IND.A/U is in a first binary state the request availability indicator R.IND.A/U indicates that the comprising reservation record request REQ.01-REQ.N is available for assignment or reassignment by the system 100 in an automated process and without further interaction with by the system 100 with the sys admin, and alternately when the request availability indicator R.IND.A/U is in an alternate second binary state the request availability indicator R.IND.A/U indicates that the comprising reservation record request REQ.01-REQ.N is not available for assignment or reassignment to an asset record A.REC.01-A.REC.N by the system 100 in an automated process and without further interaction with the sys admin.

It is understood that one or more auto rental request records REQ.01-REQ.N may have none, one or more than one feature indicators AFEAT.01-N, wherein each unique feature indicator AFEAT.01-N associates a comprising auto rental request records REQ.01-REQ.N with a particular aspect, quality or element that is not generally included within asset records A.REC.01-A.REC.N. It is further understood that the null feature value F.NULL represents a data field that does not record feature indicator AFEAT.01-N.

The process of assigning a auto rental request record REQ.01-REQ.N to an asset record A.REC.01-A.REC.N may include, or alternately consist of, writing a auto rental identifier REQ.01-REQ.N of the assigned auto rental request record REQ.01-REQ.N into the assigned asset record A.REC.01-A.REC.N.

The process of assigning an asset record A.REC.01-A.REC.N to a auto rental request record REQ.01-REQ.N may include, or alternately consist of, writing an asset identifier A.ID.01-A.ID.N of the assigned asset record A.REC.01-A.REC.N into the assigned reservation record REQ.01-REQ.N.

Referring now generally to the Figures and particularly to FIG. 16, FIG. 16 is a detailed block diagram illustrating the contents of four exemplary equipment asset records EA.REC.01, EA.REC.02, EA.REC.03 and EA.REC.N as stored in the database software DBMS SW1.

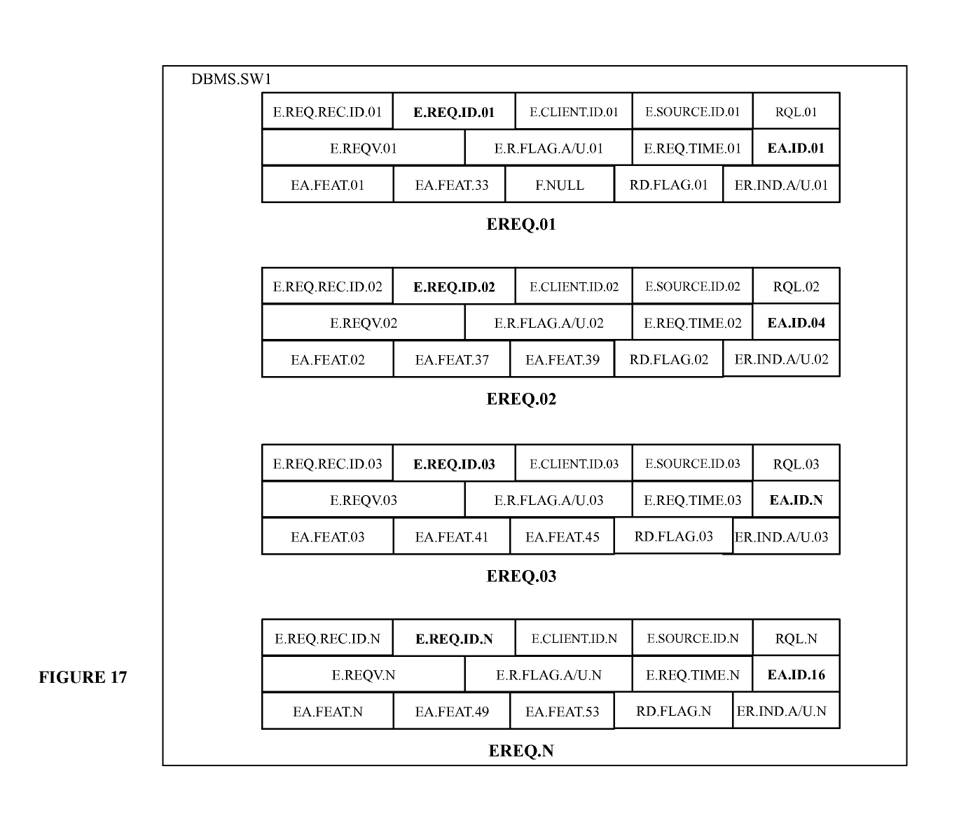

Referring now generally to the Figures and particularly to FIG. 17, FIG. 17 is a detailed block diagram illustrating the contents of four exemplary auto rental reservation request records EREQ.01, EREQ.02, EREQ.03 and EREQ.N as stored in the database software DBMS SW1.

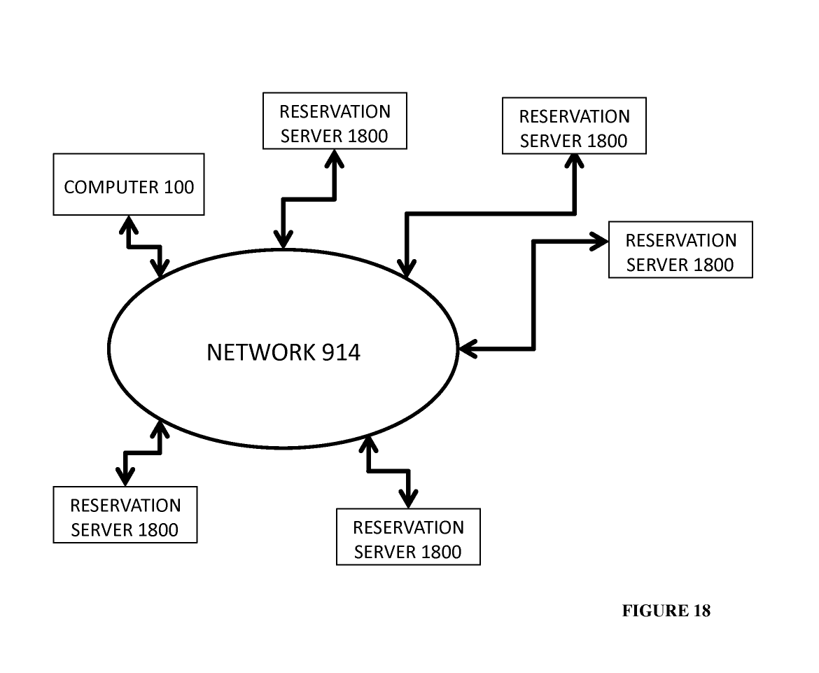

FIG. 18 is an illustration of the network 914 that bi-directionally communicatively couples the system 100 of FIG. 9 and FIG. 10 with a plurality of reservation systems 1102. One or more reservation systems 1800 are adapted to generate and transmit reservation request records REQ.01-REQ.N in whole or in part to the system 100. More particularly, one or more reservation system 1800 may be or comprise a bundled hardware and software informational technology system including but not limited to (a.) an IPHONE™ cellular telephone as marketed by Apple, Inc. of Cupertino; (b.) an IPAD™ tablet computer adapted for generation of digitized photographic documents and capable of bi-directional communications via the telephony network and the Internet 6 as marketed by Apple, Inc. of Cupertino, Calif.; (c.) an HTC TITAN ll™ cellular telephone as marketed by AT&T, Inc. of Dallas, Tex. and running a WINDOWS 7 ™ operating system as marketed by Microsoft Corporation of Redmond, Wash.; (d.) a GALAXY NEXUS™ smart phone as marketed by Samsung Group of Seoul, Republic of Korea and running an ANDROID™ operating system as marketed by Google, Inc. of Mountain View, Calif.; (e.) a TOUGHPAD™ tablet computer as marketed by Panasonic Corporation of Kadoma, Osaka, Japan and running an ANDROID™ operating system as marketed by Google, Inc. of Mountain View, Calif.; or (f.) other suitable computational system or electronic communications device known in the art.

While the present invention may be susceptible to various modifications and alternative forms, specific embodiments have been shown by way of example in the drawings and will be described in detail herein. However, it should be understood that the techniques set forth in the present disclosure are not intended to be limited to the particular forms disclosed. Rather, the invention is to cover all modifications, equivalents and alternatives falling within the spirit and scope of the disclosure as defined by the following appended claims.

We claim:

1. A method of separately assigning assets to reservation requests, the method comprising:
a. Assigning a first asset quality level to a first plurality of assets (“first level assets”);
b. Assigning a higher ranked second asset quality level to a second plurality of assets (“second level assets”);
c. Enabling access to a first plurality of requests, wherein each request of the first plurality of requests (“first level requests”) is associated with the first asset quality level and each first level request is further associated with an individual relative request value;
d. Tentatively assigning first level assets to individual requests of the first plurality of requests on an exclusive, one-to-one basis in order from first level requests with the lowest relative request value to first level requests of higher relative request values;
e. If every first level asset is assigned to a first level request and at first level, requests remains unassigned to an asset, tentatively assigning second level assets to individual unassigned first level requests on an exclusive, one-to-one basis in order from unassigned first level requests with the lowest relative request value to unassigned first level requests of higher relative request values; and
f. Presenting the tentative assignments of assets to first level requests to a human administrator for modification of the asset to request assignments.

2. The method of claim 1, wherein the at least one asset is selected from the asset group consisting of a time constrained asset, a time delineated service, a hotel room, a rental vehicle, a venue seat, an airplane, an airplane seat during a flight, an event space, a transportation capacity unit, a service provider's time, and equipment of which access to or usage of is time constrained.

3. The method of claim 1, wherein at least one asset is an equipment selected from the group of equipment consisting of motorized vehicles, electronic systems, and industrial equipment.

4. The method of claim 1, further comprising:
g. Enabling access to a second plurality of requests, wherein each request of the second plurality of requests (“second level request”) is associated with the second asset quality level and each second level request is further associated with an individual relative request value;
h. After performing step d, tentatively assigning second level assets to individual unassigned first level requests and second level requests on an exclusive, one-to-one basis in order from second level requests and unassigned first level requests with the lowest relative request value to second level requests and unassigned first level requests of higher relative request values; and
i. Presenting the tentative assignments of assets to first level requests and second level requests to a human administrator for modification of the asset to request assignments.

5. The method of claim 4, further comprising:
j. Assigning a third asset quality level to a third plurality of assets (“third level assets”), wherein the third asset quality level is ranked higher than the second asset quality level;
k. Enabling access to a third plurality of requests, wherein each request of the third plurality of requests (“third level request”) is associated with the third asset quality level and each third level request is further associated with an individual relative request value;
l. After performing step h, tentatively assigning third level assets to individual unassigned first level requests, unassigned second level requests and third level requests on an exclusive, one-to-one basis in order from third level requests, unassigned second level requests and unassigned first level requests with the lowest relative request value to third level requests, unassigned second level requests and unassigned first level requests of higher relative request values; and
m. Presenting the tentative assignments of assets to a human administrator for modification of the asset to request assignments.

6. The method of claim 5, further comprising:
n. After performing step 1, unassigning all third level assets from assignment with any request;
o. Tentatively assigning third level assets to any unassigned asset request on an exclusive, one-to-one basis in order from unassigned requests with the highest relative request value to unassigned requests of lower relative request values; and
p. Presenting the tentative assignments of assets to a human administrator for modification of the asset to request assignments.

7. The method of claim 6, further comprising:
q. After performing step o, unassigning all second level assets from assignment with any request;
r. Tentatively assigning second level assets to any unassigned asset request on an exclusive, one-to-one basis in order from unassigned requests with the highest relative request value to unassigned requests of lower relative request values; and
s. Presenting the tentative assignments of assets to a human administrator for modification of the asset to request assignments.

8. The method of claim 7, further comprising:
t. After performing step r, unassigning all first level assets from assignment with any request;
u. Tentatively assigning first level assets to any unassigned asset request on an exclusive, one-to-one basis in order from unassigned requests with the highest relative request value to unassigned requests of lower relative request values; and
v. Presenting the tentative assignments of assets to a human administrator for modification of the asset to request assignments.

9. The method of claim 8, further comprising:
w. After performing step u, assigning every first level asset to one request; and
x. Denoting any unassigned requests as recommended denials of assignment.

10. The method of claim 1, further comprising;
g. Enabling access to at least one feature laden request, wherein the at least one feature laden request specifies a potential feature of an asset;
h. Determining that at least one asset is indicated to provide the potential feature; and
i. Assigning the at least one feature laden request to the at least one feature.

11. The method of claim 10, wherein the at least one feature laden request has a lower relative request value than at least one unassigned request.

12. The method of claim 10, wherein the at least one feature laden request is associated with a lower asset quality level than an at least one unassigned request.

13. The method of claim 9, further comprising;
g. Enabling access to at least one feature laden request, wherein the at least one feature laden request specifies a potential feature of an asset;
h. Determining that at least one asset is indicated to provide the potential feature;
i. Assigning the at least one feature laden request to the at least one feature; and
k. After performing step 1, exempting the assignment of the at least one feature laden request to the at least one feature from unassignment from an asset.

14. A computer-implemented method comprising:
a. Denoting a plurality of assets (“assets”) with one of a plurality of quality levels;
b. Accepting a plurality of reservation requests (“requests”), each request associated with a quality level and with an individual request value; and
c. Assigning each request of a first plurality of requests (“first level requests”) in one-to-one correspondence with an asset of a first plurality of assets (“first level assets”) in order from lowest request value to highest request value of each first level request, wherein each first level asset and each first level request are associated with a same lowest ranked quality level.

15. The computer-implemented method of claim 14, further comprising the aspect of after the performance of step c, assigning remaining unassigned first level requests and a second plurality of requests (“second level requests”) in one-to-one correspondence to an asset of a second plurality of assets (“second level assets”) in order from lowest request value to highest request value of each second level request and unassigned first level request, wherein each second level asset and each second level request are associated with a same second quality level.

16. The computer-implemented method of claim 14, unassigning all second level assets and assigning any remaining unassigned first level requests and unassigned second level requests in order from highest request value to lowest request value of each second level request and unassigned first level request.

17. The computer-implemented method of claim 14, wherein one or more first level requests include a null request value that is equivalent to a lowest request value.

18. The computer-implemented method of claim 14, wherein one or more first level requests include a null asset quality level value that is equivalent to the lowest quality level.

19. The computer-implemented method of claim 14, wherein assignment order conflicts caused be mathematical equivalency of request values of two first requests are resolved by comparison of additional aspects of each of the two or more requests of the same request quality level.

20. A computer system comprising:
a. Means to assigning a plurality of reservation requests (“requests”) to assets in an ascending order of asset quality levels, wherein requests with lower ordered request values are assigned to assets in preference to higher ordered request values; and
b. Means to reassign the requests to assets in a descending order of individual asset quality levels, wherein requests with higher ordered request values are then assigned to assets of higher quality levels in preference to lower ordered request values, whereby a resultant assignment of requests and assets exhibits a preference for assigning higher valued requests.
